(19) United States
(12) Patent Application Publication
(10) Pub. No.: US 2020/0154310 A1
(43) Pub. Date: May 14, 2020

(54) EFFICIENT IMPLEMENTATION OF WIRELESS MEDIA TRANSMISSION

(71) Applicant: QUALCOMM Incorporated, San Diego, CA (US)

(72) Inventors: Amichai SANDEROVICH, Atlit (IL); Eran HOF, Haifa (IL)

(21) Appl. No.: 16/677,418

(22) Filed: Nov. 7, 2019

Related U.S. Application Data
(60) Provisional application No. 62/757,478, filed on Nov. 8, 2018.

(51) Int. Cl. H04W 28/06

(52) U.S. Cl. CPC H04W 28/06; H04W 84/12

(57) ABSTRACT

Certain aspects of the present disclosure provide methods and apparatus for wirelessly transmitting media. According to certain aspects, one or more analog to digital converters (ADCs) of a modem are coupled to a radio frequency (RF) chain so that the ADCs can process one or more RF signals while the modem is in a first mode, at least one of the ADCs of the modem are coupled to at least one digital to analog converter (DAC) of a media compression system so that the at least one ADC can process signals of a media stream while the modem is in a second mode, at least one first frame is generated including first information for the media stream based on the processing of the signals of the media stream by the at least one ADC of the modem, and the first frame is output for transmission.

### PRIORITY CLAIM(S)

This application claims priority to and the benefit of U.S. Provisional Application No. 62/757,478, filed on Nov. 8, 2018 which is expressly incorporated by reference in its entirety as if fully set forth below and for all applicable purposes.

### FIELD

Certain aspects of the present disclosure generally relate to wireless communications and, more particularly, to transmitting compressed media signals.

### BACKGROUND

In order to address the issue of increasing bandwidth requirements demanded for wireless communications systems, different schemes are being developed to allow multiple user terminals to communicate with a single access point by sharing the channel resources while achieving high data throughputs.

Amendment 802.11ad to the WLAN standard defines the MAC and PHY layers for very high throughput (VHT) in the 60 GHz range. Operations in the 60 GHz band allow the use of smaller antennas as compared to lower frequencies. However, as compared to operating in lower frequencies, radio waves around the 60 GHz band have high atmospheric attenuation and are subject to higher levels of absorption by atmospheric gases, rain, objects, and the like, resulting in higher free space loss. The higher free space loss can be compensated for by transmitting signals via many small antennas, for example arranged in a phased array.

Using a phased array, multiple antennas may be coordinated to form a coherent beam traveling in a desired direction (or beam), referred to as beamforming. An electrical field may be rotated to change this direction. The resulting transmission is polarized based on the electrical field. A receiver may also include antennas which can adapt to match or adapt to changing transmission polarity.

High frequency (e.g., mmWave) communication systems which may be implemented using IEEE standards such as 802.11ad and 802.11ay), may help eliminate the need for wires (“cut the cord”) in certain applications, such as streaming media applications. However, high resolution rates in such application result in very high throughput requirements, which creates a challenge for current systems.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network002E

Certain aspects of the present disclosure provide an apparatus for wireless communications. The apparatus generally includes a modem having an analog to digital converter (ADC), a processing system configured to couple the ADC of the modem to a radio frequency (RF) chain so that the ADC can process one or more RF signals while the modem is in a first mode, couple the ADC of the modem to a digital to analog converter (DAC) of a media compression system so that the ADC can process signals of a media stream while the modem is in a second mode, and generate at least one first frame including first information for the media stream based on the processing of the signals of the media stream by the ADC of the modem; and a first interface configured to output the first frame for transmission.

Certain aspects of the present disclosure provide an apparatus for wireless communications. The apparatus generally includes a first interface configured to obtain at least one frame that includes first information for a media stream, a modem having a digital analog converter (DAC); and a processing system configured to couple the DAC of the modem to a radio frequency (RF) chain so that the DAC can process one or more RF signals when the modem is in a first mode, and couple the DAC of the modem to an analog to digital converter (ADC) of a media decompression system so that the DAC can process the information for the media stream, while the modem is in a second mode.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 is a diagram illustrating signal propagation in an implementation of phased-array antennas, in accordance with certain aspects of the present disclosure.

FIG. 4 illustrates example throughputs of various interfaces.

FIG. 5 illustrates example operations for performing wireless communication, in accordance with certain aspects of the present disclosure.

FIG. 5A illustrates example components capable of performing the operations shown in FIG. 5.

FIG. 6 illustrates example operations for performing wireless communication, in accordance with certain aspects of the present disclosure.

FIG. 6A illustrates example components capable of performing the operations shown in FIG. 6.

FIG. 7 illustrates an example architecture for wirelessly transmitting media, in accordance with aspects of the present disclosure.

FIGS. 8A and 8B illustrate how the example architecture of FIG. 7 can be used to wirelessly transmit and receive media.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. The techniques described herein may be utilized in any type of applied to Single Carrier (SC) and SC-MIMO systems.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

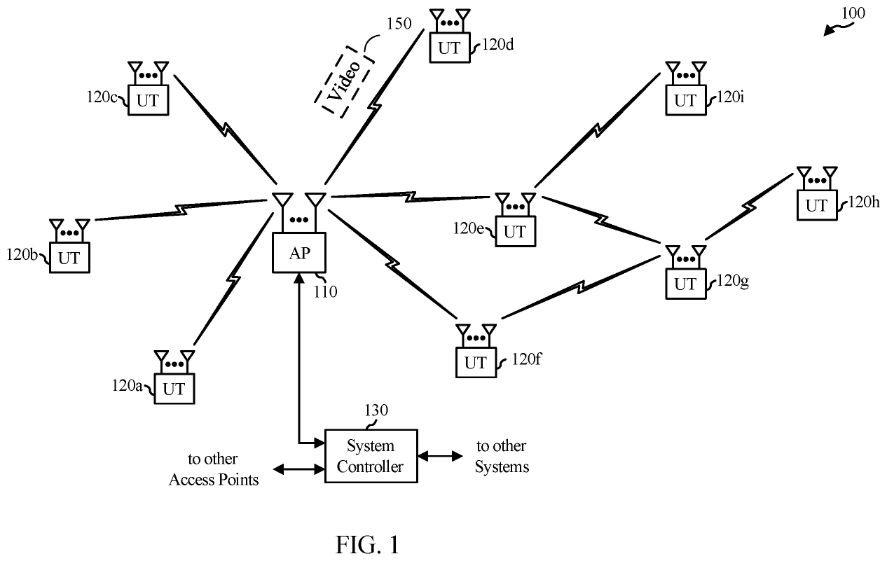

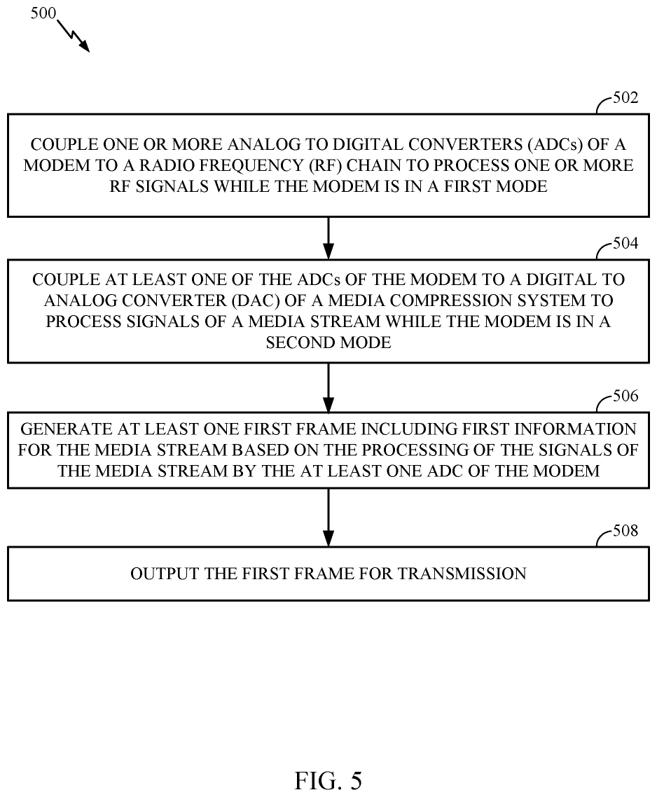

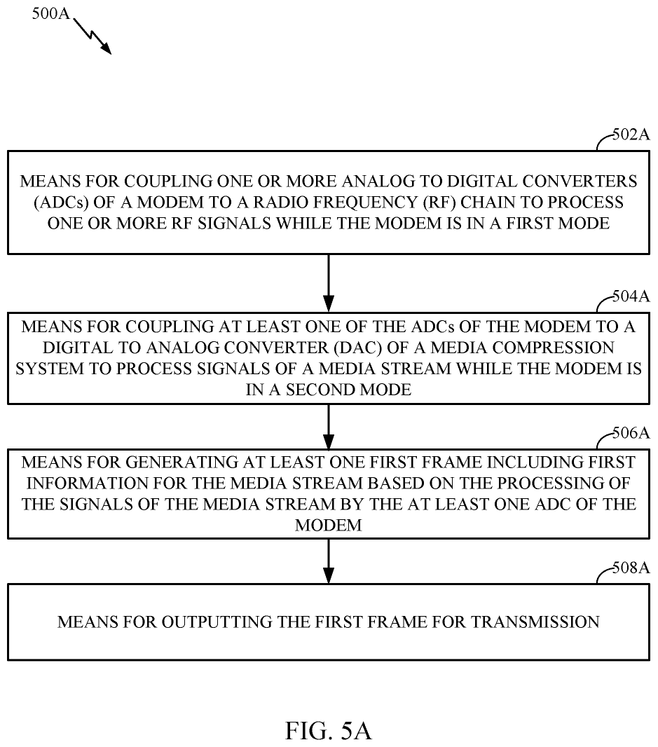

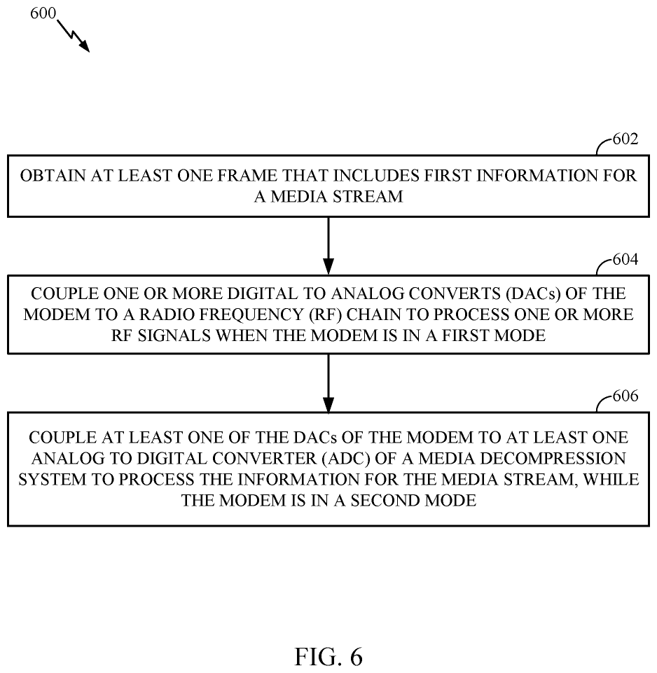

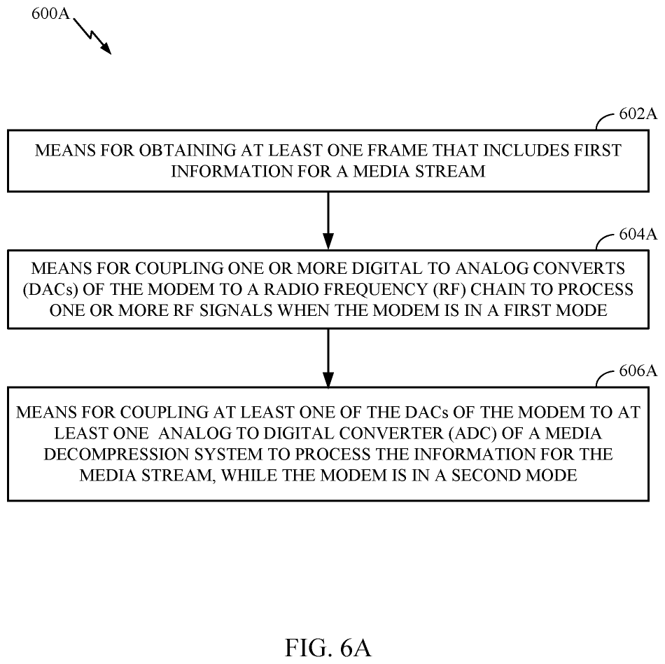

FIG. 1 illustrates a multiple-access multiple-input multiple-output (MIMO) system 100 in which aspects of the present disclosure may be practiced. For example, user terminals (UTs) 120 and/or an access terminal (AT) 110 may be configured to process and exchange compressed video frames 150 in accordance with operations 500 of FIG. 5 and/or operations 600 of FIG. 6 described in greater detail below.

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of sub-bands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

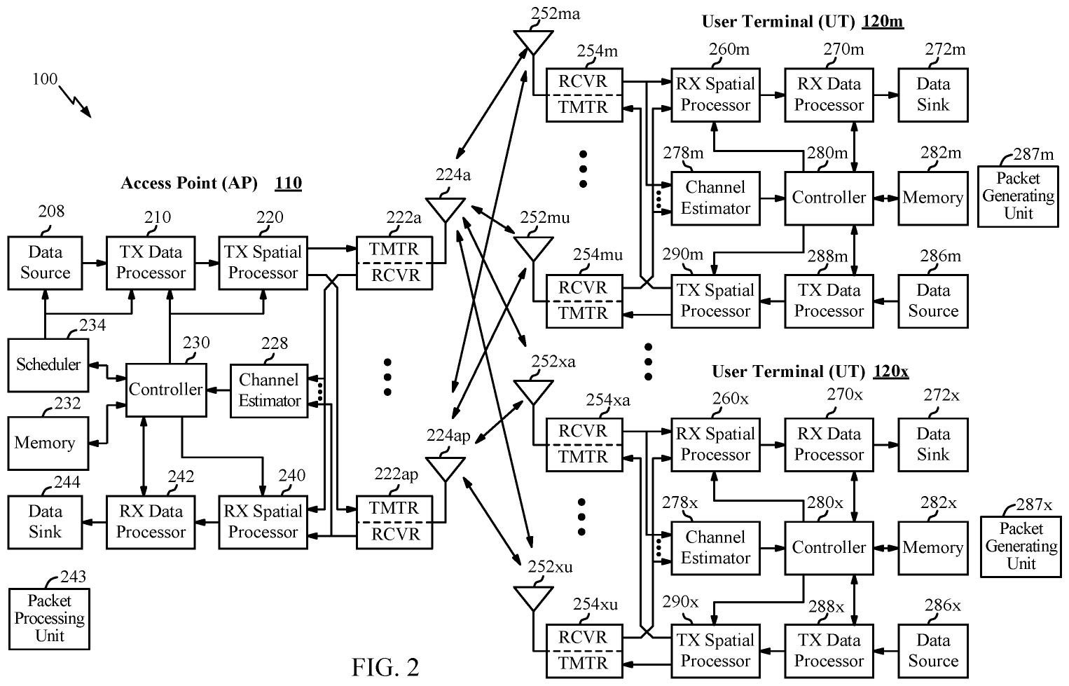

FIG. 2 illustrates a block diagram of access point 110 and two user terminals 120m and 120x capable of performing techniques described herein. For example, the various processors of AP 110 and/or UTs 120m and 120x may be configured to perform operations 500 and 600 of FIGS. 5 and 6 to process compressed video frames.

The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

As illustrated, in FIGS. 1 and 2, one or more user terminals 120 may send packets to the access point 110 as part of a UL MU-MIMO transmission, for example. Each packet may be transmitted on a set of one or more spatial streams (e.g., up to 4).

The packets may be generated by a packet generating unit 287 at the user terminal 120. The packet generating unit 287 may be implemented in the processing system of the user terminal 120, such as in the TX data processor 288, the controller 280, and/or the data source 286.

After UL transmission, a packet may be processed (e.g., decoded and interpreted) by a packet processing unit 243 at the access point 110. The packet processing unit 243 may be implemented in the process system of the access point 110, such as in the RX spatial processor 240, the RX data processor 242, or the controller 230. The packet processing unit 243 may process received packets differently, based on the packet type (e.g., with which amendment to the IEEE 802.11 standard the received packet complies). For example, the packet processing unit 243 may process a packet based on the IEEE 802.11 HEW standard, but may interpret a legacy packet (e.g., a packet complying with IEEE 802.11a/b/g) in a different manner, according to the standards amendment associated therewith.

Certain standards, such as the IEEE 802.11ay standard currently in the development phase, extend wireless communications according to existing standards (e.g., the 802.11ad standard) into the 60 GHz band. Example features to be included in such standards include channel aggregation and Channel-Bonding (CB). In general, channel aggregation utilizes multiple channels that are kept separate, while channel bonding treats the bandwidth of multiple channels as a single (wideband) channel.

As described above, operations in the 60 GHz band may allow the use of smaller antennas as compared to lower frequencies. While radio waves around the 60 GHz band have relatively high atmospheric attenuation, the higher free space loss can be compensated for by using many small antennas, for example arranged in a phased array.

Using a phased array, multiple antennas may be coordinated to form a coherent beam traveling in a desired direction. An electrical field may be rotated to change this direction. The resulting transmission is polarized based on the electrical field. A receiver may also include antennas which can adapt to match or adapt to changing transmission polarity.

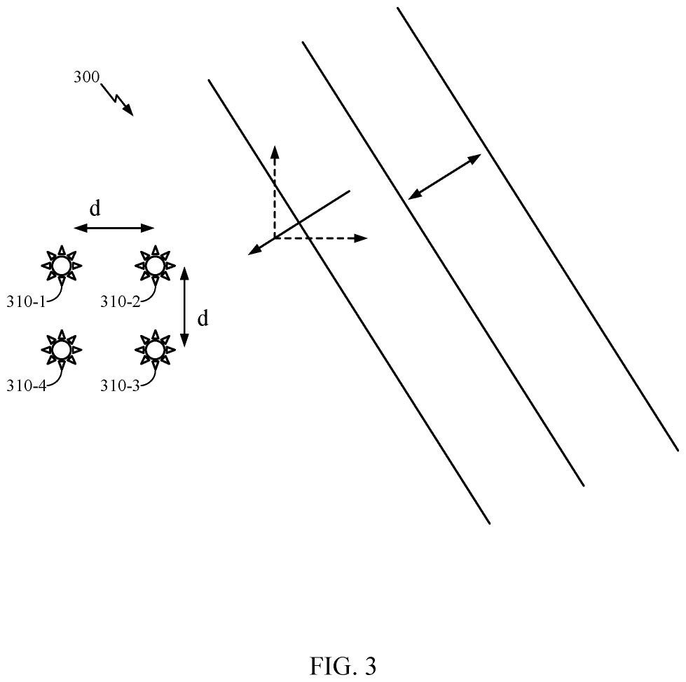

FIG. 3 is a diagram illustrating signal propagation 300 in an implementation of phased-array antennas. Phased array antennas use identical elements 310-1 through 310-4 (hereinafter referred to individually as an element 310 or collectively as elements 310). The direction in which the signal is propagated yields approximately identical gain for each element 310, while the phases of the elements 310 are different. Signals received by the elements are combined into a coherent beam with the correct gain in the desired direction.

### Example Efficient Implementation of Wireless Media Transmission

Aspects of the present disclosure provide techniques that may help achieve efficient implementation of video transmission over high frequency (e.g., mmWave) communication systems. The techniques described herein may be applied to transmit/receive compressed video (or other media) in various use cases, including virtual reality (VR), augmented reality (AR), and extended reality (XR).

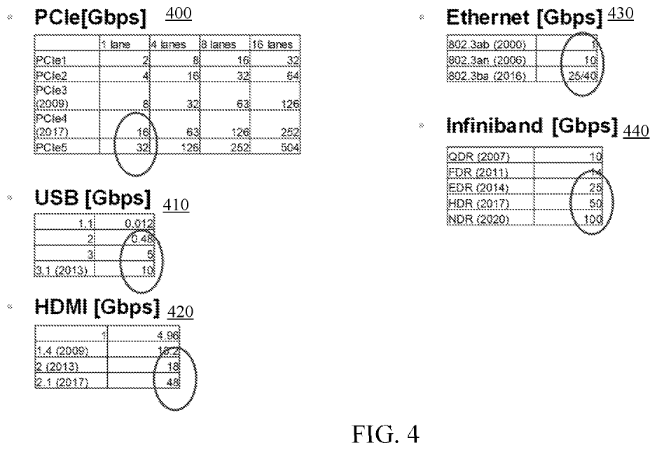

As noted above, high resolution video rates result in very high throughput, for example, when compared to data rates of regular interfaces, such as Peripheral Component Interconnect Express (PCIe) USB buses, whose current and projected data rates top out at 32 Gbps and 10 Gbps as shown in tables 400 and 410 of FIG. 4. One example of higher resolution rates is high-definition media interface (HDMI) which, as shown in table 420, reaches 48 Gbps, Ethernet, which can reach up to 40 Gbps as shown in table 430, and Infinband, which can reach up to 100 Gbps as shown in table 440. Another example interface with relatively high throughput is the display port (DP) interface.

Compressing such video to be then transmitted with low latency is of importance to users in many applications. Separating processing functionalities between video compression and communication devices (e.g., into dedicated subsystems) is often more cost effective than implementing all the functionality in a single chip. This also allows flexibility, for example, as all users may not want or need video compression. Separating processing functionality in this manner, however, presents challenges regarding transmitting the video data from the video compression system to the communication chip. For example, these challenges exist when analog or non-reliable communication formats are used, which are suitable for video transmission. Non-reliable formats include those that can be played back with an acceptable bit error rate (BER) and, thus, may not need retransmissions. As used herein in this context, non-reliable refers to formats that do not necessarily have errors, but for which errors are acceptable (such as video playback where certain errors may be imperceptible to a viewer).

Aspects of the present disclosure provide techniques that may help achieve efficient transmission of video data between a video compression system and a communication chip (e.g., a modem). For example, by reusing already existing high bandwidth interfaces, idle components in the modem, such as an analog to digital converter (ADC) and/or digital to analog converter (DAC), may be used for processing compressed video.

FIG. 5 illustrates example operations 500 for wireless communication, in accordance with certain aspects of the present disclosure. The operations 500 may be performed by a wireless node, for example, by an AP or a non-AP station (STA), to wirelessly transmit media.

The operations 500 begin, at 502, by coupling one or more ADCs of a modem to a radio frequency (RF) chain so that the ADCs can process one or more RF signals while the modem is in a first mode. At 504, the wireless node couples at least one of the ADCs of the modem to at least one digital to analog converter (DAC) of a media compression system so that the at least one ADC can process signals of a media stream while the modem is in a second mode. At 506, the wireless node generates at least one first frame including first information for the media stream based on the processing of the signals of the media stream by the at least one ADC of the modem. At 508, the wireless node outputs the first frame for transmission.

FIG. 6 illustrates example operations 600 for wireless communication, in accordance with certain aspects of the present disclosure. The operations 600 may be performed by a wireless node, for example, by an AP or a non-AP station (STA), to wirelessly receive media.

The operations 600 begin, at 602, by obtaining at least one frame that includes first information for a media stream. At 604, the wireless node couples one or more DACs of the modem to a radio frequency (RF) chain so that the DACs can process one or more RF signals when the modem is in a first mode. At 606, the wireless node couples at least one of the DACs of the modem to at least one analog to digital converter (ADC) of a media decompression system so that the at least one DAC can process the information for the media stream, while the modem is in a second mode.

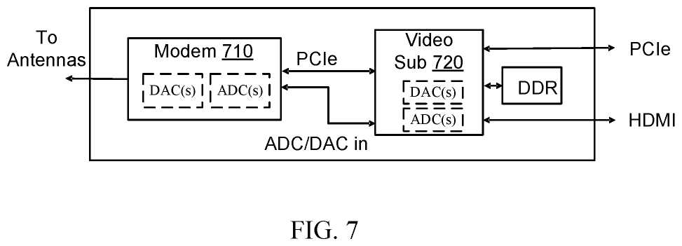

FIG. 7 illustrates an example architecture that may implement the techniques described herein. As illustrated, the architecture includes a modem 710 (or modem chip) and a video (compression/decompression) subsystem 720. As illustrated, the modem 710 and video subsystem 720 may each include one or more ADCs and one or more DACs.

As described with reference the operations above, the ADC(s) and/or DAC(s) of the modem 710 may only be used for communications processing at certain times and may be idle at other times.

For example, while the video system is transmitting, the communication chip (modem 710) usually connects its DAC to the base band and RF circuitry (which may be collectively referred to as an RF chain). If the modem 710 is operated in a time division duplexed manner, the TDD nature of the device prevents it from receiving RF signals at the same time, so the ADC (or ADCs) is not working (is idle). Thus, aspects of the present disclosure propose to use these (otherwise idle components) while the modem is in the TX mode for receiving the compressed video signals from the video compression chip (subsystem 720).

While not shown, in some cases, the architecture of FIG. 7 may include a switch, such as a switch arbiter, to provide switching functionality while keeping silicon size relatively small. Further, the interface between the modem and video compression system may include other lines (e.g., traces in a PC board), such as a clock line to synchronize the transfer of signals between the two modules. For example, the clock line may synchronize the transfer of compressed video from the video compression system to the modem when the modem is in the transmit mode. Similarly, the clock line may synchronize the transfer of compressed video (e.g., received in a frame) from the modem to the video compression system when the modem is in the receive mode.

Using the ADC/DACs in this manner, typically results in less power consumption than alternative interfaces like PCI. For example, the ADC/DAC interface may be capable of 80 Gbps with very low power (e.g., 30 mw), while a PCI interface may be capable of only a fraction of the throughput at much more power (e.g., 200 mw).

When the video system is receiving, the communication chip opens its ADC and connects it to the base-band. In this mode, the DAC is usually idle, so instead, according to the techniques presented herein, the DAC will be used to carry the signal from the modem into the video decompression chip.

As described herein, reusing existing components of the modem (when they would otherwise be idle) may lead to an efficient implementation, with enhanced performance in terms of compression/latency while avoiding the addition of expensive interfaces.

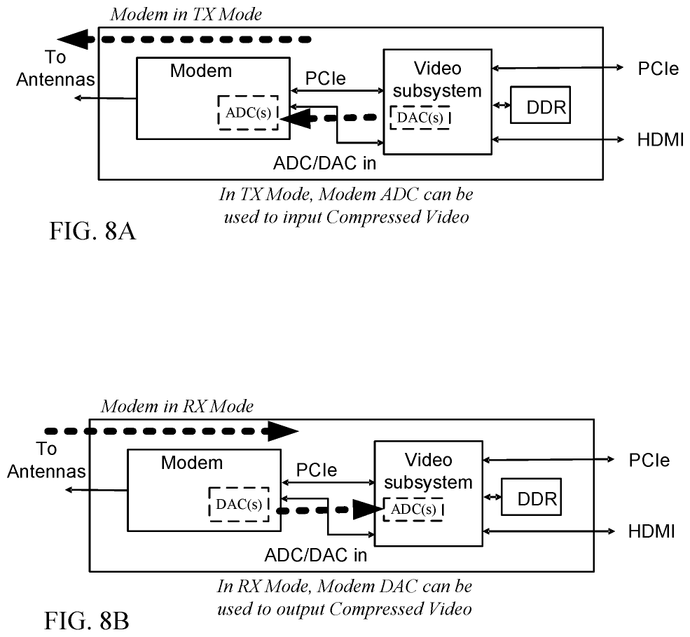

FIG. 8A illustrates how the modem ADC may be used as an interface for compressed video from the video subsystem. As illustrated in FIG. 8A, while the modem is in a TX mode, the otherwise idle ADC can be used to input compressed video from the video compression chip. In this manner, the modem can receive (via the ADC) compressed video, process it into a frame, and then send it out for transmission (e.g., through its DAC to the RF chain). In some cases, transmit processing may also include at least of one of pulse shaping filtering, pilot insertion, header addition, or MAC encapsulation. Pulse shaping filtering, pilot insertion, header addition and/or MAC encapsulation could be performed as part of ADC processing or via separate processing.

FIG. 8B illustrates how the modem DAC may be used as an interface to transfer compressed video from the modem to the video subsystem. As illustrated in FIG. 8B, while the modem is in an RX mode, the otherwise idle DAC can be used to output compressed video (e.g., received in a frame) to the video compression chip. In this manner, the modem can receive compressed video (from the RF chain) in a frame, processing it into signals, and then send the signals through the DAC to the video subsystem.

As shown in FIG. 7, the modem 710 and video subsystem 720 may each include one or more ADCs and one or more DACs, but the number of components on each system/subsystem may differ. Further, depending on the particular implementation and/or particular operating mode, only a subset of modem components may be coupled to only a subset of video subsystem components. Further, in some modes of operation, an ADC may be used in reduced capacity (e.g., ½ rate), based on different processing requirements of the modem (for wireless communications processing) versus the media compression subsystem. Different modes may also be used to achieve different effects, such as lower power consumption in reduced power modes (to conserve battery power).

In some cases, receive processing may also include at least of one of equalization, synchronization, header decoding, or MAC decapsulation. The equalization and/or synchronization may be performed by processing components between the ADC and the DAC, such that the DAC sends corrected information to the media coupled ADC. The MAC decapsulation and header decoding may be used as additional “side” information to help a processing system correctly obtain information from the frame.

Processing (compression and/or decompression) of the media stream may involve one or a combination of different types of transformation algorithms. For example, the media stream processing may include performing a digital cosine transformation (DCT) and/or a Hilbert transformation. The media processing may also include dithering, whereby a certain type of noise may be added to images to prevent large-scale distracting patterns, such as color banding.

As described above, due to the nature of most media, some amount of loss is acceptable and may actually be imperceptible to an end user. For example, if one bit of video data is lost, the effect on a single pixel of a display may be imperceptible to an end user. Aspects of the present disclosure may take advantage of this by using the video subsystem to transmit analog/unreliable signal, for example, by connecting the video subsystem DAC to the modem ADC. In some cases, signals between the modem and video compression system may pass through additional filtering and/or gain amplifier (or amplifiers).

The ADC on the modem would then take the video signal, processing it in the modem, passing through ADC to antennas for transmission, for example, as payload in a frame. The frame may not be a standard frame, but could include analog signals attached to the start of frames, analog signals from the video subsystem. In some cases, the data may also include digital information coming from/encoded by vid subsystem (e.g., via a PCIe interface) so there may be no additional processing in the modem (e.g., except filtering/attaching headers).

As illustrated in FIG. 7, in some cases, in addition to a first interface via the modem ADC/DAC, video data may be exchanged via a conventional interface (e.g., PCIe). This approach may allow more reliable video data to be sent (e.g., with error correction) via the conventional interface, while a non-reliable video stream (e.g., that can operate with a high bit error rate) is transferred via the ADC/DAC interface.

In some cases, the modem may be used as a network IP device. In such cases, compressed video may be obtained via an IP address of the modem and/or compressed video may be provided to the modem via the IP address. In other words, an apparatus operating according to aspects presented herein may be associated with an internet protocol (IP) address and the IP address is included as a destination address in a frame (e.g., with compressed video).

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 and 600 illustrated in FIGS. 5 and 6 correspond to means 500A and 600A illustrated in FIGS. 5A and 6A.

For example, means for exchanging may comprise a transmitter (e.g., the transmitter unit 222) and/or an antenna(s) 224 of the access point 110 or the transmitter unit 254 and/or antenna(s) 252 of the user terminal 120 illustrated in FIG. 2 and/or a receiver (e.g., the receiver unit 222) and/or an antenna(s) 224 of the access point 110 or the receiver unit 254 and/or antenna(s) 252 of the user terminal 120 illustrated in FIG. 2. Means for causing, means for performing, means for providing, means for coupling, means for obtaining, means for including, means for determining, means for detecting, or means for generating may comprise a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the user terminal 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
a modem having one or more analog to digital converters (ADCs);
a processing system configured to
couple the ADCs of the modem to a radio frequency (RF) chain so that the ADCs can process one or more RF signals while the modem is in a first mode,
couple at least one of the ADCs of the modem to at least one digital to analog converter (DAC) of a media compression system so that the at least one ADC can process signals of a media stream while the modem is in a second mode, and
generate at least one first frame including first information for the media stream based on the processing of the signals of the media stream by the at least one ADC of the modem; and
a first interface configured to output the first frame for transmission.

2. The apparatus of claim 1, wherein the processing system is configured to couple the at least one ADC of the modem to the at least one DAC of the media compression system through at least one of a gain amplifier or a filter.

3. The apparatus of claim 1, wherein the media stream comprises at least one of:
a non-reliable stream that can be played back with an acceptable bit error rate (BER); or
a non-reliable stream without any retransmissions.

4. The apparatus of claim 3, wherein:
the processing system is further configured to include second information for the media stream in the at least one first frame; and
the interface is configured to output the first information and the second information for transmission in first and second manners, respectively, said second manner being more reliable than the first manner.

5. The apparatus of claim 4, wherein:
the second information is output for transmission with error correction that is not included with compressed media information.

6. The apparatus of claim 1, wherein:
the modem also has one or more DACs;
the apparatus further comprises a second interface configured to obtain a second frame that includes media information; and
the processing system is further configured to
couple at least one of the DACs of the modem to at least one ADC of the media compression system so that the at least one DAC of the modem can process the media information in the second frame while the modem is in the first mode.

7. The apparatus of claim 1, further comprising the media compression system wherein:
the media stream is input to the media compression system via at least one of:
a High-Definition Multimedia Interface (HDMI) port;
a Peripheral Component Interconnect Express (PCIe) port; or
a display port (DP).

8. The apparatus of claim 1, further comprising a switch arbiter, wherein the processing system is configured to couple the at least one ADC of the modem to the RF chain or to the at least one DAC of the media compression system via the switch arbiter.

9. The apparatus of claim 1, wherein the generation comprises at least one of pulse shaping filtering or pilot insertion.

10. The apparatus of claim 1, wherein the generation comprises at least one of header addition or media access control (MAC) encapsulation.

11. The apparatus of claim 1, wherein the processing system is configured to couple the at least one ADC of the modem to the RF chain or to the at least one DAC of the media compression system via one or more traces on a PC board.

12. The apparatus of claim 1, wherein the apparatus is associated with an internet protocol (IP) address and the IP address is included as a source address in the at least one first frame.

13. An apparatus for wireless communications, comprising:
a first interface configured to obtain at least one frame that includes first information for a media stream;
a modem having one or more digital analog converters (DACs); and
a processing system configured to
couple the DACs of the modem to a radio frequency (RF) chain so that the DACs can process one or more RF signals when the modem is in a first mode, and
couple at least one of the DACs of the modem to at least one analog to digital converter (ADC) of a media decompression system so that the at least one DAC can process the first information for the media stream, while the modem is in a second mode.

14. The apparatus of claim 13, wherein the processing system is configured to couple the at least one DAC of the modem to the at least one ADC of the media decompression system via at least one of a gain amplifier or a filter.

15. The apparatus of claim 13, wherein the media stream comprises at least one of:
a non-reliable stream that can be played back with an acceptable bit error rate (BER); or
a non-reliable stream without any retransmissions.

16. The apparatus of claim 15, wherein:
the at least one frame also includes second information for the media stream; and
the first interface is configured to obtain the second information in a more reliable manner than the first information.

17. The apparatus of claim 16, wherein:
the second information is obtained with error correction that is not included with the first information.

18. The apparatus of claim 13, further comprising a switch arbiter, wherein the processing system is configured to couple the at least one DAC of the modem to the RF chain or to the at least one ADC of the media decompression system via the switch arbiter.

19. The apparatus of claim 13, wherein:
the apparatus further comprises one or more components configured to perform at least one of equalization of the first information for the media stream or synchronization of the first information within the media stream; and
the at least one DAC of the modem is configured to provide the equalized or synchronized first information to the at least one ADC of the media decompression system.

20. The apparatus of claim 13, wherein the processing system is further configured to perform at least one of header decoding or media access control (MAC) decapsulation to obtain the first information from the at least one frame.

21. The apparatus of claim 13, wherein the processing system is configured to couple the at least one DAC of the modem to the RF chain or to the at least one ADC of the media decompression system via one or more traces on a PC board.

22. The apparatus of claim 13, wherein the apparatus is associated with an internet protocol (IP) address and the IP address is included as a destination address in the at least one frame.

23. A method for wireless communications by an apparatus, comprising:
coupling one or more analog to digital converters (ADCs) of a modem to one or more radio frequency (RF) chains so that the ADCs can process one or more RF signals while the modem is in a first mode;
coupling at least one of the ADCs of the modem to at least one digital to analog converter (DAC) of a media compression system so that the at least one ADC can process signals of a media stream while the modem is in a second mode;
generating at least one first frame including first information for the media stream based on the processing of the signals of the media stream by the at least one ADC of the modem; and
outputting the first frame for transmission.

24. A method for wireless communications by an apparatus, comprising:
obtaining at least one frame that includes first information for a media stream;
coupling one or more digital analog converters (DACs) of a modem to a radio frequency (RF) chain so that the DACs can process one or more RF signals when the modem is in a first mode; and
coupling at least one of the DACs of the modem to at least one analog to digital converter (ADC) of a media decompression system so that the at least one DAC can process the first information for the media stream, while the modem is in a second mode.
